(19) United States
(12) Patent Application Publication
(10) Pub. No.: US 2004/0139616 A1
(43) Pub. Date: Jul. 22, 2004

(54) Snips with removable blades

(76) Inventor: J. Conrad Vogel, Lincoln, NE (US)

Correspondence Address: BRINKS HOFER GILSON & LIONE, P.O. BOX 10395, CHICAGO, IL, 60610, US

(21) Appl. No.: 10/712,439

(22) Filed: Nov. 13, 2003

Related U.S. Application Data
(60) Provisional application No. 60/426,709, filed on Nov. 15, 2002.

(51) Int. Cl. B26B 13/00

(52) U.S. Cl. 30/260

(57) ABSTRACT

A tool that comprises first and second cooperating members, each of the first and second cooperating members comprising at least a jaw section and a handle. The first and second cooperating members are detachably interconnected in a mutually overlapping relationship so as to permit movement of the jaw sections relative to one another by the handles. A first blade comprises at least a first and a second edge and the first edge is counterposed to the second edge across a longitudinal axis of the blade. The first blade is removably juxtaposed to the jaw section of the first cooperating member. A third edge is juxtaposed to the jaw section of said second cooperating member.

### RELATED APPLICATIONS

This patent application claims the benefit of the filing date under 35 U.S.C. § 119(e) of Provisional U.S. Patent Application Serial No. 60/426,709, filed Nov. 15, 2002, the entirety of which is incorporated herein.

### FIELD OF INVENTION

This invention relates to hand tools and more specifically to hand-held snips, scissors or similar pivotal member cutting tools.

### BACKGROUND OF THE INVENTION

Conventional snips, scissors or similar pivotal member cutting tools (herein referred to collectively as “snips”) have been used for many years. It is widely recognized that a substantial drawback of these and similar tools is a short life span due to the blades dulling with use.

Conventional snips are usually manufactured with the blades permanently attached to hand levers. If at least one blade of the snips is ruined, the entire hand tool becomes unusable and should be discarded. One way to solve this problem is to provide the snips with removable blades. An example of a cutting device with removable blades is described in U.S. Pat. No. 2,801,468 (“the '468 patent”). Because the tool described in the '468 patent has removable blades, its lifespan is longer than that of conventional snips with permanent blades. However, each blade is designed with only one cutting edge and needs to be replaced as soon as the single cutting edge is ruined. Furthermore, removal and replacement of the blades in the '468 patent could be time-consuming and expensive in view of the plurality of the fasteners used for connection between the jaws and the blades.

Another pivotal cutting tool, described in U.S. Pat. No. 5,197,194 (“the '194 patent”), has provided a partial solution to some of the shortcomings cited above. The tool described in the '194 patent has two removable blades, each with two edges. One edge of each blade is positioned within the jaws to provide the cutting edges for the tool; each spare edge extends into the handle. However, the blade in the '194 patent is difficult manufacture because the shape, large length-to-width ratio and long perimeter of the blade require both efforts to maintain the blade's straightness and a large stamping force, and cause a significant blank-out loss. Moreover, the blades of this tool require additional fasteners to fix the blade in place and impart a curvature to generate interference.

### BRIEF SUMMARY OF THE INVENTION

In one aspect of the invention, a tool is provided that comprises first and second cooperating members, each of the first and second cooperating members comprising at least a jaw section and a handle. The first and second cooperating members are detachably interconnected in a mutually overlapping relationship so as to permit movement of the jaw sections relative to one another by the handles. A first blade comprises at least a first and a second edge, and the first edge is counterposed to the second edge across a longitudinal axis of the blade. The first blade is removably juxtaposed to the jaw section of the first cooperating member. A third edge is juxtaposed to the jaw section of the second cooperating member.

In another aspect of the invention, there is provided a method of switching cutting edges in a pivotal member cutting tool which comprises providing a pivotal member cutting tool comprising two cooperating members detachably interconnected to each other. The tool further comprises a first removable blade with at least two cutting edges separating the cooperating members. The method further comprises rotating the first removable blade 180 degrees around its longitudinal axis and reconnecting the cooperating members.

In yet another aspect of the invention, there is an improved scissor-action cutting tool, the improvement of which comprises at least one removable blade comprising at least two edges counterposed across a longitudinal axis of the blade.

In yet another aspect of the invention, there is a cutting tool kit which comprises a pair of handles, wherein each of the handles defines a pocket capable of receiving a blade. The kit also comprises a first pair of blades, each having counterposed cutting edges. The first pair of blades is reversibly positionable on the handles. There is also at least a second pair of blades having a different configuration from the first pair of blades and reversibly positionable on the handles.

### BRIEF DESCRIPTION OF SEVERAL VIEWS OF THE DRAWINGS

The present embodiments of the invention are illustrated in the accompanying drawings wherein:

FIG. 1 is a front elevational view of one embodiment of the snips with removable blades, in accordance with the present invention;

FIG. 2 is an elevational view showing a single cooperating member or lever of the embodiment of FIG. 1;

FIG. 2a is a cross-sectional view of the cooperating member of FIG. 2 according to the sectional line A-A;

FIG. 3 is an elevational view of one embodiment of the blade, in accordance with the present invention;

FIG. 3a is a cross-sectional view according to line B-B of FIG. 3;

FIG. 3b is an alternative cross-sectional view according to line B-B of FIG. 3;

FIG. 4 is an elevational view showing a second embodiment of the snips with one removable blade, in accordance with the present invention;

FIG. 5 is an elevational view of a third embodiment of the snips, having an off-set jaw portion with removable blades, in accordance with the present invention; and

FIG. 6 is an exploded view of the embodiment of FIG. 1, showing a possible assembly of the snips of the present invention.

### DETAILED DESCRIPTION OF THE PREFERRED EMBODIMENTS

Although a specific embodiment of the invention will now be described with reference to the drawings, it should be understood that the embodiment shown is by way of example only and merely illustrative of but one of the many possible specific embodiments which can represent applications of the principles of the invention. Various changes and modifications, obvious to one skilled in the art to which the invention pertains, are deemed to be within the spirit, scope and contemplation of the invention and are further defined in the appended claims.

In particular, this invention, while identified as “snips” herein, encompasses all varieties of snips, scissors, and all similarly designed pivotal member cutting tools. While the embodiment described in detail in the drawings and the specification is designed to cut metal, the invention described herein includes embodiments designed to cut paper, cloth, cardboard, rubber and all other materials which can be cut by pivotal member cutting tools.

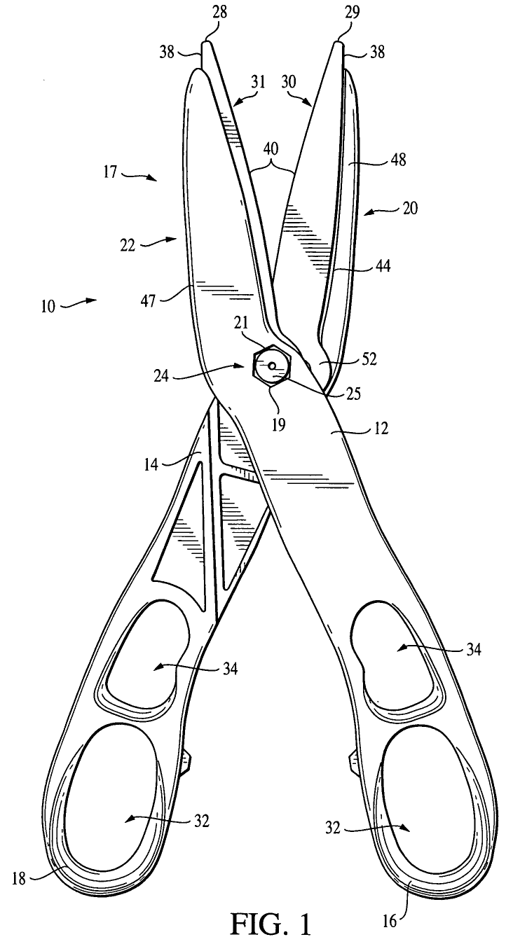

With reference to the drawings, an illustrative embodiment of the snips 10 in accordance with the present invention is shown in FIG. 1. The snips 10 embodying this invention comprises a pair of substantially identical levers or cooperating members 12, 14. The first cooperating member 12 consists of a first handle 16 and a first jaw section or member 22. The second cooperating member 14 consists of a second handle 18 and a second jaw section or member 20. In one embodiment, the handles 16, 18 have distal finger loops 32 and proximal finger loops 34.

In use, the thumb of the operator's hand (preferably the right hand in the embodiment shown) is inserted into one of the two hand-grip loops 32, 34 of one of the members 12 and preferably at least two of the remaining fingers of the same hand are inserted into one or both of the hand-grip loops 32, 34 of the other cooperating member 14. To alleviate hand strain and provide for widely variable jaw angles during operation, the snips 10 can be equipped with proximal loops 34 in addition to distal loops 32, as shown in FIG. 1. The benefits of having two pairs of finger loops are further described in U.S. Pat. No. 5,197,194, the entirety of which is incorporated herein by reference. The snips 10 can alternatively be made with only one finger loop per cooperating member.

The cooperating members 12, 14 are typically manufactured from plastic, glass-reinforced nylon, glass-reinforced polycarbonate, or cast aluminum. However, any suitable material may be used; materials that are both lightweight and strong are preferable. For example, it is known in the industry to use magnesium alloy for the manufacture of cooperating members. This material is lighter in weight than the steel used in conventional snips and very strong.

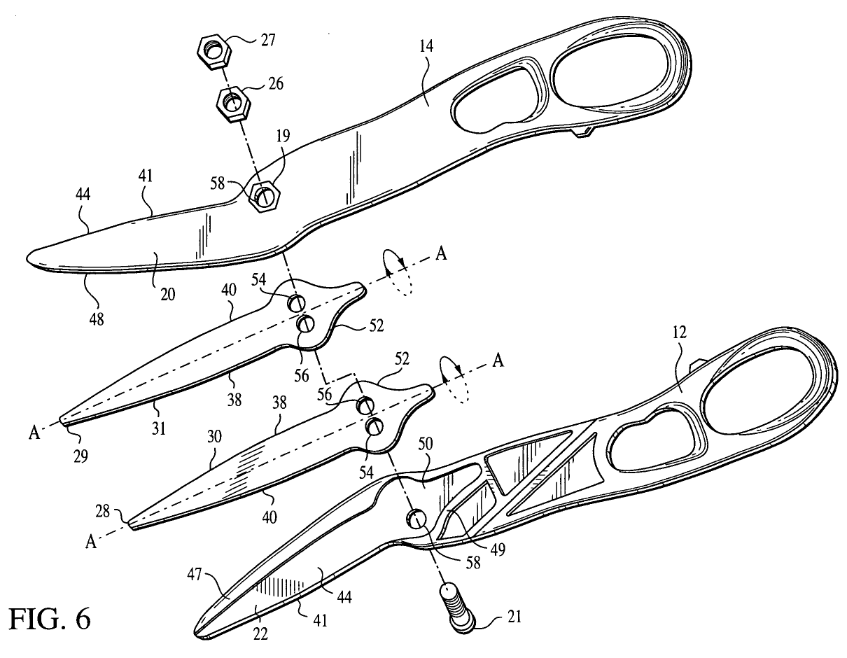

A pivot or interconnecting means 24 interconnects the cooperating members 12, 14 in mutually overlapping relationship, so as to permit rotational movement of these members 12, 14 about the pivot, relative to one another in parallel planes. Any conventional pivot 24 can be used, including, for example, a bolt, screw, rivet or similar joint shaft. The pivot 24 can be secured in place by a conventional nut 26 or locking nut, as shown in FIG. 6. A secured pivot 24 prevents unintentional disassembly of the component parts of the snips 10.

In FIG. 1, it is shown that the cooperating member 12 has a hexagonal recess 19. The round bolt head 25 sits in the hexagonal recess 19. The at least partially threaded bolt 21 can be secured by two nuts, a first hexagonal nut 26 which sits in a fixed position in the hexagonal recess 19 of the other cooperating member 14, and a second nut 27 which is tightened on top of the first nut 26, as shown in FIG. 6. This allows one cooperating member 14 to remain stationary with respect to the pivot 24, while the cooperating member 12 pivots with respect to the pivot 24. However, any other conventional way of movably interconnecting the cooperating members 12, 14 is contemplated by this invention.

The typical jaw section 17 of the snips is illustrated in FIG. 1. The jaw section 17 comprises the jaw members or jaws 20, 22 and two substantially identical blades 30, 31 removably juxtaposed to each of the two jaws 20, 22. The spare edges 38 of the blades 30, 31 are shielded by their respective flanges 47, 48 except at the tips 28, 29, while the cutting edges 40 are exposed. The jaw section 17 can be of a shape or length that facilitates the intended purpose of the snips 10. For example, the jaw section 17 can be short so that the snips 10 are better suited for cutting wire.

The snips 10 can be actuated to cut an object using conventional methods, by moving one handle 16 towards the other handle 18 when the jaws 20, 22 at least partially straddle an object. The jaws 20, 22 can be released by moving the handles 16, 18 away from one another.

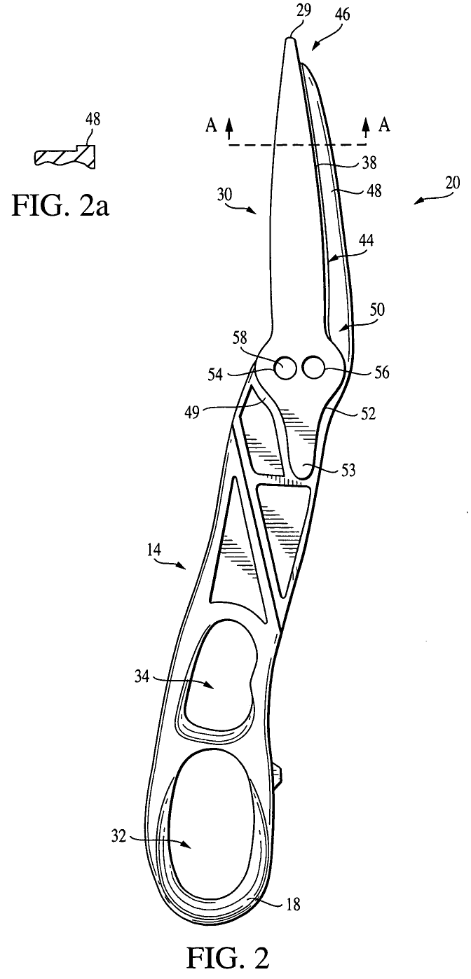

A single cooperating member 14 is illustrated in FIG. 2. The inside of the jaw 20 of the cooperating member 14 has a recessed portion to provide a blade pocket or receiving means 44. The pocket 44 typically extends from the forward tip 46 of the jaw 20, to the area of each cooperating member 14 surrounding the pivot aperture 58. The widened portion 50 of the pocket 44 that surrounds the pivot aperture 58 accommodates the oblong tang 52 and tab 53 of the blade 30, which has two apertures 54, 56 of its own. The form of the pocket 44 creates a flange 48 along the outer curved perimeter of the jaw 20 and an inner flange 49. The flange 48 abuts and shields the spare edge 38 of the blade 30. It is shown in FIG. 2 that the flange 48 extends substantially along the entire outer length of the jaw 20.

The receiving means or cutting blade pocket 44 is designed to closely accommodate the blade 30. It is shown in FIG. 1 that when the blade 30 is positioned within the pocket 44 of one cooperating member 14, the cutting edge 40 extends out of the pocket 44 to face the blade 31 within the opposite cooperating member 12. Meanwhile, the spare edge 38 is positioned within the interior of the pocket 44. This spare edge 38 is protected by the flange 48 from undesirable exposure, so that it neither wears, nor poses a danger to the user.

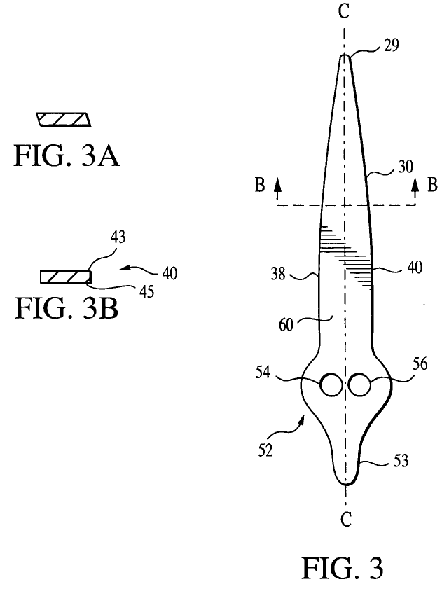

One embodiment of the blade 30 of the invention is most clearly shown in FIG. 3. The blade 30 is substantially symmetrical about its longitudinal axis C-C and is shaped to substantially conform to the receiving means or pocket 44. Two holes 54 and 56 are provided within the tang 52 for registration with the pivot aperture 58. In the embodiment shown, the hole 54 located nearest the cutting edge 40 of the blade 30 registers with the pivot aperture 58 of the jaw portion 20; the opposite hole 56 will register with the pivot aperture 58 when the blade 30 is rotated as described herein. As shown in FIG. 6, when the tool 10 is assembled, the bolt 21 passes through the hole 54 that registers with the pivot aperture 58, further securing the blades 30, 31 in place. Other methods of securing the blades 30, 31 in place are within the scope of this invention.

The blade 30 shown in FIG. 3 includes first 38 and second 40 cutting edges spaced from each other by a central portion 60 and mutually counterposed across a longitudinal axis C-C. A slight curvature (not shown) is ground into both sides of the central portion 60, to impart the interference between the two blades 30, 31 when the snips 10 is assembled. The first 38 and second 40 edges extend from the tang 52, tapering to form the tip of the blade 29. The blade tip 29 can be sharp and strong enough to pierce a metal sheet or similar material; it is also within the scope of this invention to provide the blade 30 with a sharper or differently formed piercing portion. The blade 30 can be beveled as shown in FIG. 3a or have 90-degree cutting edges as in FIG. 3b.

The blade 30 of this invention is typically manufactured from tool steel, such as “1074” high carbon steel. However, any suitably strong material could be used for this purpose. The blade 30 can be stamped out of a metal sheet; the shape of the blade 30 reduces blank-out loss. Because the blade 30 has a shorter perimeter than other blades known in the art, the metal press used to make the blade 30 of this invention can exert less force. The blade 30 can have a relatively small length-to-width ratio, in addition to other design benefits, which keep the blade 30 flat during manufacture and assembly.

The blade 30 has a tang 52 located at the base of the blade 30, opposite from the blade tip 29. The tang 52 serves to keep the blade 30 in place while the snips 10 are being used. The tang 52 is also useful for providing a handle with which the whole blade 30 can be steadied during manufacture and assembly. For example, the tang 52 can be gripped while the edges 38, 40 of the blade 30 are being sharpened. A tab 53 preferably forms an integral part of the tang 52. When the blade 30 is stamped out, the tab 53 can be longer to assist sharpening and grinding of the blade 30, and later be trimmed to fit within the pocket 44. Alternatively, the blade 30 can be made without a tab 53.

The blade 30 tapers towards its tip 29 with respect to the C-C axis of the blade 30, providing the blade 30 with a greater width near the tang 52. The cutting blade pocket or receiving means 44 is designed to closely receive the tang 52 and blade 30. When the blade is positioned within the interior of one of the cooperating members 12, 14, the edges of the tang 52 and tab 53 contact the flange 48 and the inner flange 49 so that the entire blade 30 is held more securely in place during assembly and operation. This creates an effective locking means, significantly simplifying assembly of the snips 10 and replacement of the blade 30.

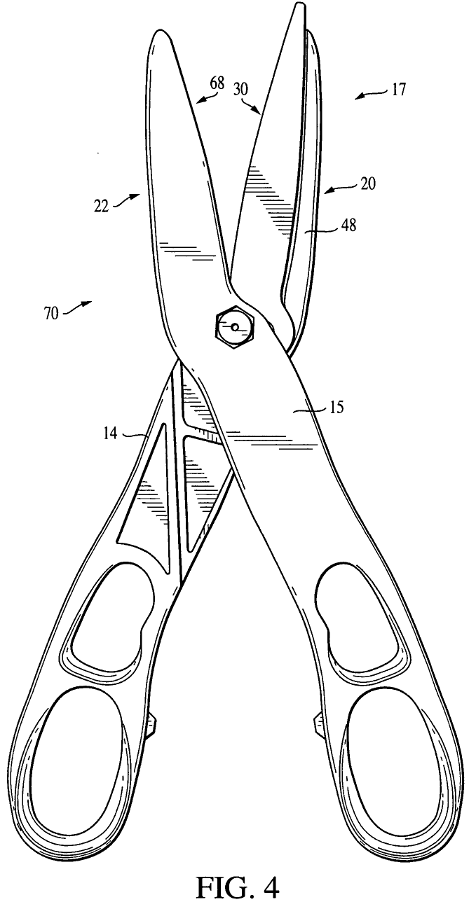

As shown in FIG. 4, an embodiment of a snips 70 having a jaw section 17 comprising a permanent blade 68 fixed to a cooperating member 15 and one removable blade 30 associated with a cooperating member 14, is within the scope of this invention. The removable blade 30 is partially protected by the flange 48, as described above.

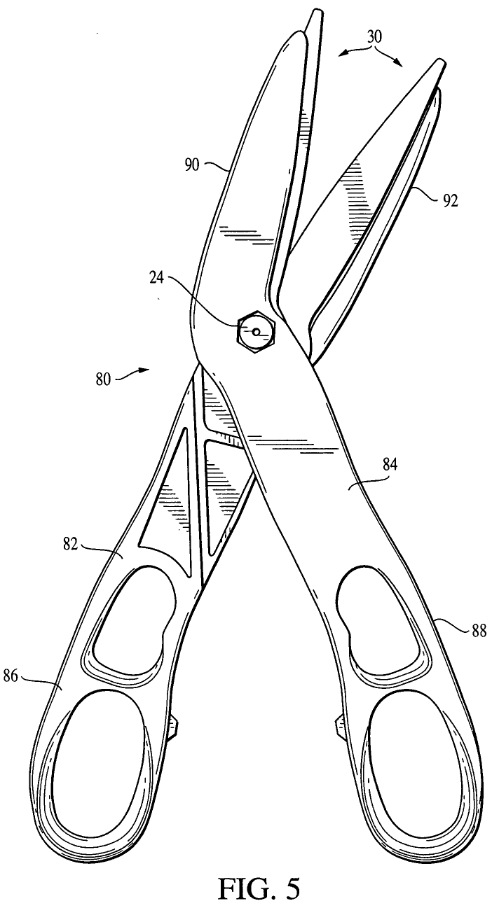

FIG. 5 illustrates application of the removable blade concept of the present invention to an offset snips embodiment 80. The offset snips 80 consists of two levers or cooperating members 82, 84 wherein each has its own configuration. Each cooperating member 82, 84 consists of a handle 86, 88 and a jaw section 90, 92. The cooperating members 82, 84 are connected by a pivot or interconnecting means 24, so as to permit movement of these members relative to one another. As discussed above, any interconnecting means is within the scope of this invention. The jaw sections 90, 92 are similar in design to that of the snips 10 at FIG. 1. The principle difference in the offset snips 80 is that the jaw sections 90, 92 are set at an angle to the upper handle 88.

Both cooperating members 82, 84 of the offset snips 80 of FIG. 5 can utilize substantially identical blades 30. An example of a suitable blade is illustrated in FIG. 3. The blades 30 are shaped to conform to the blade pockets (not shown) as described in reference to FIG. 2. The assembly steps for the offset snips 80 are identical to those discussed below with reference to FIGS. 1 and 6.

During the assembly procedure, both cooperating members 12, 14 of FIG. 1 are usually positioned with their respective pockets 44 facing an upward direction as in FIG. 2. Next, each blade 30, 31 is inserted into the corresponding pocket 44 from above, so that pocket 44 prevents it from sliding outwardly. The blades 30, 31 are preferably designed so that only their longitudinal orientation needs to be considered when placing them into the cooperating members 12, 14. Preassembled in this way, the cooperating members 12, 14 are brought together and interconnected by the pivot 24, as shown in FIG. 6.

In the assembled condition, the cooperating members 12, 14 and the blades 30, 31 are kept together by the bolt 21 and nuts 26, 27. The blades 30, 31 are in close contact with each other and with the corresponding cooperating members 12, 14. No additional fasteners have been typically required by such construction. However, other ways of securing the blades 30, 31 are also within the scope of this invention. For example, a plurality of small apertures along the center of the blade 60 can register with similar apertures provided in the recessed jaw sections. These smaller registering apertures allow for insertion of fasteners which removably secure the blade in the blade pocket. The fasteners may be of a hexagonal socket, Phillips, or any other conventional type.

After assembly of the snips 10, both blades 30, 31 are positioned within their respective pockets 44. The cutting edges 40 of the blades 30, 31 extend outwardly past or beyond the openings 41 of the pockets 44 to mutually cooperate with each other. At the same time, the spare cutting edges 38 are situated within the interior of the pockets 44 and protected from undesirable contact and exposure by the flanges 47, 48. The flanges 47, 48 do not necessarily extend to the blade tips 28, 29. For the blades 30, 31 to be in sliding contact with each other during operation, the width of the blades 30, 31 is preferably greater than or equal to the depth of the respective pocket 44. There is a widened pocket 50 which is adapted to receive the blade's tang 52, as shown on one cooperating member 12 in FIG. 6.

When the first cutting edge 40 becomes dull or damaged, it is possible in the present invention to substitute the spare cutting edge 38 for the unusable first one 40. To perform this task, the pivot 24 is removed in order to gain access to the pockets 44 of the cooperating members 12, 14. Then, the blades 30, 31 are released from engagement with their respective pockets 44 and moved in such a manner that their respective spare cutting edges 38 are substituted for the used respective cutting edges 40. Such substitution is possible in view of the symmetrical configuration of the blades 30, 31; a 180-degree rotation of the blades 30, 31 around their respective longitudinal axes accomplishes the substitution. One possible position of such blades 30, 31 is illustrated in FIG. 6, in which the edges 40 represent ruined cutting edges of the corresponding blades 30, 31 which should be substituted for the fresh and unused cutting edges 38. When the replacement task is accomplished, the sharp spare cutting edges 38 are positioned on the inside of the jaws 20, 22 and the unusable first cutting edges 40 are situated within their respective pockets 44.

Referring to FIG. 3, if the cutting surfaces of the blade 30 are thin, then the entire thickness of the edge can be dulled. However, if the blades 30 are thick enough and not beveled, as in FIG. 3b, then only the inner portion (43, for example) of the edge 40 that immediately engages the opposite blade during use becomes dull or ruined. The other portion 45 of the same edge 40 does not contact the opposite blade and is not directly exposed to the friction and shear forces generated in the cutting process; it therefore remains sharp. With such a blade, it is possible to exploit all four available cutting edges by rotating the blades 30, 31 as described herein, and by exchanging them between handles 12, 14. The first blade replacement involves the rotation of the blades 30 as described above. The next replacement involves switching the blades 30, 31 between the respective cooperative members 12, 14 to expose a third cutting edge. Finally, another blade rotation will expose the fourth cutting edge. This feature substantially increases the number of spare edges and further extends the life span of the tool.

A kit which contains a pair handles and multiple pairs of interchangeable blades is also within the scope of this invention. The blade pairs in the kit can have different configurations or different characteristics adapted for certain kinds of cutting. For example, one set of blades can have duller safety edges, be made of a stronger alloy, or have a blunter tip, in comparison to another pair of blades in the kit. Other blade variations are also within the scope of this invention. This allows the user to select an appropriate set of blades for a project and use them interchangeably with the cooperating members 12, 14. In the alternative, interchangeable configurations of the members 12, 14 may also be provided. Such members may be of different handle sizes, lengths, etc., thereby increasing the range of projects for which a particular cutting device kit is useful.

1. A tool comprising:
first and second cooperating members, each of said first and second cooperating members comprising at least a jaw section and a handle, said first and second cooperating members detachably interconnected in a mutually overlapping relationship so as to permit movement of said jaw sections relative to one another by said handles;
a first blade comprising at least a first and a second edge, said first edge counterposed to said second edge across a longitudinal axis of said blade, said first blade removably juxtaposed to said jaw section of said first cooperating member; and
a third edge juxtaposed to said jaw section of said second cooperating member.

2. The tool of claim 1, further comprising a pocket formed in said jaw section of said first cooperating member, said pocket adapted to removably receive at least a portion of said first blade.

3. The tool of claim 2, wherein said first edge of said first blade is shielded by a flange which defines an edge of said pocket, and wherein said second edge of said first blade is exposed for cutting.

4. The tool of claim 2, wherein said first edge projects beyond an edge of said jaw section.

5. The tool of claim 4, further comprising a tang forming the base of said first blade.

6. The tool of claim 5, wherein each of said cooperating members defines an aperture capable of accommodating a pivot means.

7. The tool of claim 6, wherein each of said cooperating members defines an outward-facing hexagonal recess, and said cooperating members are detachably interconnected with a bolt fastened with a hexagonal nut.

8. The tool of claim 6, wherein said tang of said first blade defines at least one tang aperture, and wherein said tang aperture is aligned with said apertures of said cooperating members.

9. The tool of claim 8, wherein said tang of said first blade defines two tang apertures, and wherein one of said tang apertures is aligned with said apertures of said cooperating members.

10. The tool of claim 9, further comprising a tab protruding from said tang of said first blade.

11. The tool of claim 10 wherein said tool is hand-operated.

12. The tool of claim 11, wherein each of said cooperating members has at least two finger loops.

13. The tool of claim 1, wherein said jaw section of one of said cooperating members is set at an angle to said handle section of the same cooperating member.

14. The tool of claim 1, further comprising a tang which forms a base of said first blade.

15. The tool of claim 1, wherein said third edge is permanently fixed to said jaw of said second cooperating member.

16. The tool of claim 2, wherein said cooperating members are attached to each other by a manually removable nut.

17. The tool of claim 1, wherein a second blade comprises said third edge and a fourth edge, said third edge counterposed to said fourth edge across a longitudinal axis of said second blade.

18. The tool of claim 17, wherein said third edge projects beyond an edge of said jaw section.

19. The tool of claim 18, wherein each of said cooperating members defines an aperture capable of accommodating a pivot means.

20. The tool of claim 18, wherein said cooperating members are detachably interconnected with a bolt fastened with a hexagonal nut which passes through said apertures.

21. The tool of claim 20, wherein each of said blades comprises a tang forming a base of each of said tangs.

22. The tool of claim 21, further comprising a tab attached to each of said blades.

23. The tool of claim 22, wherein each of said tangs defines one tang aperture aligned with said aperture of said cooperating members.

24. The tool of claim 23, wherein each of said tangs defines two tang apertures.

25. The tool of claim 24, wherein at least one of said cooperating members has at least two finger loops.

26. A method of modifying a cutting tool, comprising:
providing a pivotal member cutting tool comprising two cooperating members detachably interconnected to each other, said tool further comprising a first removable blade having at least two cutting edges positioned at opposing portions of said blade;
separating said cooperating members;
rotating said first removable blade 180 degrees around its longitudinal axis;
reconnecting said cooperating members.

27. The method of claim 26, further comprising providing a second removable blade having at least two edges.

28. The method of claim 27, further comprising rotating said second removable blade around said longitudinal axis.

29. The method of claim 28, further comprising exchanging said first and second blades between respective cooperating members.

30. An improved scissor-action cutting tool, the improvement comprising:
one removable blade comprising two edges counterposed across a longitudinal axis of said blade.

31. The tool of claim 30, wherein said tool is manually actuated.

32. The tool of claim 31, the improvement further comprising a second removable blade comprising two edges counterposed across a longitudinal axis of said second blade.

33. A cutting tool kit, comprising:
a pair of handles, wherein each of said handles defines a pocket capable of receiving a blade;
a first pair of blades, each having counterposed cutting edges, each of said first pair of blades reversibly positionable on respective ones of said handles;
at least a second pair of blades having a different configuration from said first pair of blades, said at least second pair of blades being reversibly positionable on said handles.

34. The kit of claim 33, wherein said first or said second pair of blades may be mounted on said handles.

35. The kit of claim 34, wherein each of said first pair of blades has a sharper point than each of said second pair of blades.

36. The kit of claim 34, wherein each of said first pair of blades has a duller cutting edge than each of said second pair of blades.

37. The kit of claim 34, wherein each of said first pair of blades comprises a stronger alloy than each of said second pair of blades.

38. The kit of claim 34, wherein each of said first pair of blades has a tip that is more curved than a tip of each of said second pair of blades.
